(19) United States
(12) Patent Application Publication
(10) Pub. No.: US 2023/0075515 A1
(43) Pub. Date: Mar. 9, 2023

(54) Thermoplastic Elastomer Composition For Producing Rotationally Molded Articles

(71) Applicant: Celanese International Corporation, Irving, TX (US)

(72) Inventors: Youhao Yang, Union, KY (US); Brian Dudley Coleman, Union, KY (US)

(21) Appl. No.: 17/898,769

(22) Filed: Aug. 30, 2022

Related U.S. Application Data
(60) Provisional application No. 63/240,540, filed on Sep. 3, 2021.

(51) Int. Cl. C08L 67/02

(52) U.S. Cl. CPC C08L 67/02; C08L 2205/025

(57) ABSTRACT

A polymer composition containing a thermoplastic elastomer in an amount of greater than 50% by weight is formulated in the form of particles for rotational molding applications. The thermoplastic elastomer can be a copolyester elastomer. Various different components are formulated into a polymer powder that is then used in rotational molding to produce various different articles.

### RELATED APPLICATIONS

The present application is based upon and claims priority to U.S. Provisional patent application Ser. No. 63/240,540, having a filing date of Sep. 3, 2021, and which is incorporated herein by reference.

### BACKGROUND

Hollow vessels can be made using various different types of molding processes and techniques. One particular type of process is referred to as rotational molding. During rotational molding, a polymer material is placed in a mold and heated above its softening temperature causing the polymer material to become molten and flow. During the heating process, the mold is rotated about at least one axis, and typically about at least two different axes. The centrifugal force causes the polymer material to line the walls of the mold and form a hollow vessel. Rotational molding offers various advantages because the process can produce seamless hollow products with high complexity.

In the past, rotational molding has been used to produce all different types of containers and tanks that have high impact resistance strength. The use of particular polymers in constructing the rotational molded articles has been limited due to the somewhat narrow processing window that is available in rotational molding systems. In this regard, polyethylene polymers and polyamide polymers have been conventionally used in rotational molding processes. The polymers have been used to produce, for instance, containers designed to hold bulk materials and liquids. Rotational molding products used in the past include linings for hot water tanks, small engine fuel tanks, and the like.

In the past, those skilled in the art have also attempted to produce rotationally molded articles containing elastomeric polymers. In many applications, for example, elastomeric polymers were combined with other polymers in order to improve impact resistance. Various different advantages and benefits may be obtained, however, if rotationally molded articles were produced primarily from the elastomeric polymer. Such articles, for instance, would be flexible and have desirable stretch properties for many applications. In addition, products could be produced that are unitary and seamless, thus resulting in a product having increased integrity and strength.

In view of the above, a need currently exists for a polymer composition containing primarily an elastomeric polymer for use in rotational molding applications. In addition, a need exists for an elastomeric polymer composition for use in rotational molding applications that can produce a distinctive and uniform color. A need also exists for articles rotationally molded from the elastomeric polymer compositions described above.

### SUMMARY

The present disclosure is generally directed to a (1) pre-compounded composition well suited to incorporating one or more additives such as coloring agents into an elastomeric polymer composition; (2) an elastomeric compounded polymer composition containing polymer particles well suited for use in rotational molding applications; and (3) rotationally molded articles produced from an elastomeric polymer composition. Rotationally molded articles made in accordance with the present disclosure offer various advantages and benefits. For instance, articles can be produced having a uniform and consistent wall thickness distribution and an excellent balance of mechanical properties. In addition, molded articles can be produced displaying all different colors in a uniform and aesthetic manner. In addition, compounded polymer compositions made according to the present disclosure for use in rotational molding applications have excellent flow properties allowing for the composition to be easily handled and loaded into a mold. In fact, the compounded polymer composition of the present disclosure can display faster cycle times and use less material in comparison to many other polymer products used in the past.

In one aspect, the present disclosure is directed to a polymer composition for producing a compounded feed material suitable for use in rotational molding processes. The polymer composition comprises copolyester elastomer pellets. The copolyester elastomer pellets are present in the composition in an amount from about 80% by weight to about 95% by weight, such as in an amount from about 88% by weight to about 92% by weight. The composition further contains a copolyester elastomer powder. The copolyester elastomer powder is present in the polymer composition in an amount from about 5% by weight to about 20% by weight, such as from about 8% by weight to about 12% by weight. The polymer composition further contains one or more coloring agents comprising color pigments. The one or more coloring agents are present in the polymer composition in an amount from about 0.01% by weight to about 1% by weight, such as from about 0.01% by weight to about 0.8% by weight.

The copolyester elastomer powder can have a particle size distribution such that at least 50% by weight of the particles have a particle size of less than about 1,000 microns. The average particle size of the particles can be from about 250 microns to about 1,000 microns, such as from about 500 microns to about 1,000 microns. The copolyester elastomer pellets, on the other hand, can generally have a length of greater than about 0.5 mm, such as greater than about 1 mm, such as greater than about 1.5 mm, and generally less than about 3 mm, such as less than about 2 mm.

All different types of coloring agents can be incorporated into the polymer composition. The coloring agents generally comprise pigments. The naming system for pigments generally includes the following formula: “P” for pigment followed by the first letter of the hue or color (e.g. “Y” for yellow, “R” for red, etc.) followed by a sequential number provided by the Colour Index. Coloring agents that can be incorporated into the polymer composition in accordance with the present disclosure include PO 64, PR 254, PBk 12, PG 17, PB 29, PBk 7, PW 6, PR 101, PY 119, PB 15:1, PR 122, PV 19, PB 15:4, PY 138, PY 110, PR 202, and mixtures thereof.

The copolyester elastomer contained in the pellets and the copolyester elastomer contained in the powder can be identical or different elastomers. Copolyester elastomers that may be incorporated into the polymer composition include, for instance, thermoplastic ester ether elastomers. In one aspect, the copolyester elastomer comprises a block copolymer of polybutylene terephthalate and polyether segments or dimerdiol segments. In one particular embodiment, the copolyester elastomer contained in the polymer composition comprises a block copolymer of polybutylene terephthalate segments and polytetramethylene ether glycol terephthalate segments. The copolyester elastomer, in one aspect, can have a Shore D hardness of less than about 80, such as less than about 70, such as less than about 60, such as less than about 50, such as less than about 45, and generally greater than about 10, such as greater than about 20, such as greater than about 30.

The polymer composition as described above can be melt blended together and formed into a feed material for a rotational molding process. In one aspect, the polymer composition described above can be compounded into pellets which are then ground into a desired particle size distribution.

For example, in one embodiment, the present disclosure is directed to a compounded polymer composition for rotational molding applications. The polymer composition comprises polymer particles containing a copolyester elastomer. The copolyester elastomer is present in the polymer composition in an amount of at least about 80% by weight. The polymer composition further contains one or more coloring agents. The polymer particles can have a particle size distribution that has been found to be effective for rotational molding applications. For example, the polymer particles can have an average particle size of from about 300 microns to about 1,100 microns, such as from about 400 microns to about 850 microns. The polymer particles can have a bulk density of from about 300 g/L to about 650 g/L, such as from about 450 g/L to about 500 g/L. The polymer particles can have excellent flow properties. For example, the polymer particles can have a flowability of less than about 40 sec/100 g, such as less than about 35 sec/100 g, such as less than about 30 sec/100 g.

The present disclosure is also directed to rotationally molded articles produced from the polymer composition described above. In one aspect, the rotationally molded article can be an exterior covering for furniture.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a piece of furniture that may be made in accordance with the present disclosure and

FIG. 2 is a perspective view of another embodiment of a piece of furniture that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition containing primarily a thermoplastic elastomer that can be used in rotational molding applications. The present disclosure overcomes various different obstacles in producing a composition that can be used to form rotationally molded articles. In particular, the present disclosure is directed to a polymer composition that is formulated in order to incorporate one or more coloring agents into the composition that will later produce rotationally molded articles that not only display a uniform color but also create a distinctive and aesthetic appearance.

The present disclosure is also directed to a compounded polymer composition that can contain one or more coloring agents as described above. The compounded composition can be in the form of a powder having a controlled particle size and particle size distribution that has been found to provide advantages and benefits during rotational molding processes. For instance, the powder can have fluid-like flow properties. Thus, the polymer composition can be easy to handle for loading into the mold and will circulate uniformly within the mold during rotation of the mold. The particle size distribution, for instance, can lead to the formation of articles with greater accuracy and tolerances.

The particle size distribution in combination with the combination of different components that make up the polymer composition can also produce a polymer composition with lower shrinkage and less internal stress during the molding process. The polymer composition, once molten, flows uniformly over the surface of the mold and produces molded articles with little to no voids.

The compounded polymer composition in the form of a powder can also have a particle size distribution and an ideal bulk density for rotational molding applications. Ultimately, the compounded polymer composition of the present disclosure can display extremely fast cycle times while using a minimal amount of the polymer composition in forming articles with the desired mechanical and physical properties.

The present disclosure is also directed to unique and seamless hollow articles formed through rotational molding processes using the compounded polymer composition of the present disclosure. The molded articles, as will be explained below, have enhanced integrity in that the articles are unitary and made from a continuous single piece of material.

### Pre-Compounded Polymer Composition

In forming rotationally molded articles in accordance with the present disclosure, the initial step is to create a mixture of components that can then be compounded together, ground to a desired particle size distribution, and then loaded into a rotational molding apparatus. The pre-compounded polymer composition of the present disclosure includes a combination of thermoplastic elastomer pellets and a thermoplastic elastomer powder that has been found to readily incorporate other components and additives in forming a compounded product. For example, in one aspect, the pre-compounded polymer composition can be used to incorporate one or more coloring agents into a compounded polymer composition that produces molded articles with a uniform color or hue.

The pre-compounded polymer composition in accordance with the present disclosure is a mixture of different components. The pre-compounded polymer composition or mixture generally contains thermoplastic elastomer pellets combined with a thermoplastic elastomer powder and one or more additives, such as one or more coloring agents. The pre-compounded polymer composition, in one embodiment, contains one or more thermoplastic elastomers in an amount greater than about 80% by weight, such as in an amount greater than about 85% by weight, such as in an amount greater than about 90% by weight.

In one aspect, the one or more thermoplastic elastomers contained in the composition are copolyester elastomers. The polymer composition can be formulated to contain a single copolyester elastomer or can be formulated to contain a plurality of copolyester elastomers. The thermoplastic polyester elastomer can be, for instance, a thermoplastic copolyester elastomer that comprises a thermoplastic ester ether elastomer. In one aspect, the thermoplastic polyester elastomer can be a thermoplastic copolyester elastomer that comprises a block copolymer of polybutylene terephthalate and polyether segments.

In one embodiment, the polymer composition may contain a segmented thermoplastic copolyester. The thermoplastic polyester elastomer, for example, may comprise a multi-block copolymer. Useful segmented thermoplastic copolyester elastomers include a multiplicity of recurring long chain ester units and short chain ester units joined head to tail through ester linkages. The long chain units can be represented by the formula

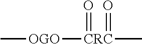

and the short chain units can be represented by the formula

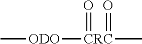

where G is a divalent radical remaining after the removal of the terminal hydroxyl groups from a long chain polymeric glycol having a number average molecular weight in the range from about 600 to 6,000 and a melting point below about 55° C., R is a hydrocarbon radical remaining after removal of the carboxyl groups from dicarboxylic acid having a molecular weight less than about 300, and D is a divalent radical remaining after removal of hydroxyl groups from low molecular weight diols having a molecular weight less than about 250.

The short chain ester units in the copolyetherester provide about 15 to 95% of the weight of the copolyetherester, and about 50 to 100% of the short chain ester units in the copolyetherester are identical.

The term “long chain ester units” refers to the reaction product of a long chain glycol with a dicarboxylic acid. The long chain glycols are polymeric glycols having terminal (or nearly terminal as possible) hydroxy groups, a molecular weight above about 600, such as from about 600-6000, a melting point less than about 55° C. and a carbon to oxygen ratio about 2.0 or greater. The long chain glycols are generally poly(alkylene oxide) glycols or glycol esters of poly(alkylene oxide) dicarboxylic acids. Any substituent groups can be present which do not interfere with polymerization of the compound with glycol(s) or dicarboxylic acid(s), as the case may be. The hydroxy functional groups of the long chain glycols which react to form the copolyesters can be terminal groups to the extent possible. The terminal hydroxy groups can be placed on end capping glycol units different from the chain, i.e., ethylene oxide end groups on poly(propylene oxide glycol).

The term “short chain ester units” refers to low molecular weight compounds or polymer chain units having molecular weights less than about 550. They are made by reacting a low molecular weight diol (below about 250) with a dicarboxylic acid.

The dicarboxylic acids may include the condensation polymerization equivalents of dicarboxylic acids, that is, their esters or ester-forming derivatives such as acid chlorides and anhydrides, or other derivatives which behave substantially like dicarboxylic acids in a polymerization reaction with a glycol.

The dicarboxylic acid monomers for the elastomer have a molecular weight less than about 300. They can be aromatic, aliphatic or cycloaliphatic. The dicarboxylic acids can contain any substituent groups or combination thereof which do not interfere with the polymerization reaction. Representative dicarboxylic acids include terephthalic and isophthalic acids, bibenzoic acid, substituted dicarboxy compounds with benzene nuclei such as bis(p-carboxyphenyl) methane, p-oxy-(p-carboxyphenyl) benzoic acid, ethylene-bis(p-oxybenzoic acid), 1,5-naphthalene dicarboxylic acid, 2,6-naphthalene dicarboxylic acid, 2,7-naphthalene dicarboxylic acid, phenanthralenedicarboxylic acid, anthralenedicarboxylic acid, 4,4′-sulfonyl dibenzoic acid, etc. and C₁-C₁₀ alkyl and other ring substitution derivatives thereof such as halo, alkoxy or aryl derivatives. Hydroxy acids such as p (β-hydroxyethoxy) benzoic acid can also be used providing an aromatic dicarboxylic acid is also present.

Representative aliphatic and cycloaliphatic acids are sebacic acid, 1,3-or 1,4-cyclohexane dicarboxylic acid, adipic acid, glutaric acid, succinic acid, carbonic acid, oxalic acid, itaconic acid, azelaic acid, diethylmalonic acid, fumaric acid, citraconic acid, allylmalonate acid, 4-cyclohexene-1,2-dicarboxylate acid, pimelic acid, suberic acid, 2,5-diethyladipic acid, 2-ethylsuberic acid, 2,2,3,3-tetramethylsuccinic acid, cyclopentanedicarboxylic acid, decahydro-1,5- (or 2,6-) naphthylenedicarboxylic acid, 4,4′-bicyclohexyl dicarboxylic acid, 4,4′-methylenebis(cyclohexyl carboxylic acid), 3,4-furan dicarboxylate, and 1,1-cyclobutane dicarboxylate.

The dicarboxylic acid may have a molecular weight less than about 300. In one embodiment, phenylene dicarboxylic acids are used such as terephthalic and isophthalic acid.

Included among the low molecular weight (less than about 250) diols which react to form short chain ester units of the copolyesters are acyclic, alicyclic and aromatic dihydroxy compounds. Included are dials with 2-15 carbon atoms such as ethylene, propylene, isobutylene, tetramethylene, pentamethylene, 2,2-dimethyltrimethylene, hexamethylene and decamethylene glycols, dihydroxy cyclohexane, cyclohexane dimethanol, resorcinol, hydroquinone, 1,5-dihydroxy naphthalene, etc. Also included are aliphatic diols containing 2-8 carbon atoms. Included among the bis-phenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol). Low molecular weight diols also include such equivalent ester-forming derivatives.

Long chain glycols which can be used in preparing the polymers include the poly(alkylene oxide) glycols such as polyethylene glycol, poly(1,2- and 1,3-propylene oxide) glycol, poly(tetramethylene oxide) glycol, poly(pentamethylene oxide) glycol, poly(hexamethylene oxide) glycol, poly(heptamethylene oxide) glycol, poly(octamethylene oxide) glycol, poly(nonamethylene oxide) glycol and poly(1,2-butylene oxide) glycol; random and block copolymers of ethylene oxide and 1,2-propylene oxide and poly-formals prepared by reacting formaldehyde with glycols, such as pentamethylene glycol, or mixtures of glycols, such as a mixture of tetramethylene and pentamethylene glycols.

In addition, the dicarboxymethyl acids of poly(alkylene oxides) such as the one derived from polytetramethylene oxide HOOCCH₂(OCH₂CH₂CH₂CH₂)ₓOCH₂COOH IV can be used to form long chain glycols in situ. Polythioether glycols and polyester glycols also provide useful products. In using polyester glycols, care must generally be exercised to control a tendency to interchange during melt polymerization, but certain sterically hindered polyesters, e.g., poly(2,2-dimethyl-1,3-propylene adipate), poly(2,2-dimethyl-1,3-propylene/2-methyl-2-ethyl-1,3-propylene 2,5-dimethylterephthalate), poly(2,2-dimethyl-1,3-propylene/2,2-diethyl-1,3-propylene, 1,4 cyclohexanedicarboxylate) and poly(1,2-cyclohexylenedimethylene/2,2-dimethyl-1,3-propylene cyclohexanedicarboxylate) can be utilized under normal reaction conditions and other more reactive polyester glycols can be used if a short residence time is employed. Either polybutadiene or polyisoprene glycols, copolymers of these and saturated hydrogenation products of these materials are also satisfactory long chain polymeric glycols. In addition, the glycol esters of dicarboxylic acids formed by oxidation of polyisobutylenediene copolymers are useful raw materials.

Although the long chain dicarboxylic acids (IV) above can be added to the polymerization reaction mixture as acids, they react with the low molecular weight diols(s) present, these always being in excess, to form the corresponding poly(alkylene oxide) ester glycols which then polymerize to form the G units in the polymer chain, these particular G units having the structure

-DOCCH₂(OCH₂CH₂CH₂CH₂)ₓOCH₂COODO

when only one low molecular weight diol (corresponding to D) is employed. When more than one diol is used, there can be a different diol cap at each end of the polymer chain units. Such dicarboxylic acids may also react with long chain glycols if they are present, in which case a material is obtained having a formula the same as V above except the Ds are replaced with polymeric residues of the long chain glycols. The extent to which this reaction occurs is quite small, however, since the low molecular weight diol is present in considerable molar excess.

In place of a single low molecular weight diol, a mixture of such diols can be used. In place of a single long chain glycol or equivalent, a mixture of such compounds can be utilized, and in place of a single low molecular weight dicarboxylic acid or its equivalent, a mixture of two or more can be used in preparing the thermoplastic copolyester elastomers which can be employed in the compositions of this invention. Thus, the letter “G” in Formula II above can represent the residue of a single long chain glycol or the residue of several different glycols, the letter D in Formula III can represent the residue of one or several low molecular weight dials and the letter R in Formulas II and III can represent the residue of one or several dicarboxylic acids. When an aliphatic acid is used which contains a mixture of geometric isomers, such as the cis-trans isomers of cyclohexane dicarboxylic acid, the different isomers should be considered as different compounds forming different short chain ester units with the same diol in the copolyesters. The copolyester elastomer can be made by conventional ester interchange reaction.

Copolyether esters with alternating, random-length sequences of either long chain or short chain oxyalkylene glycols can contain repeating high melting blocks that are capable of crystallization and substantially amorphous blocks with a relatively low glass transition temperature. In one embodiment, the hard segments can be composed of tetramethylene terephthalate units and the soft segments may be derived from aliphatic polyether and polyester glycols. Of particular advantage, the above materials resist deformation at surface temperatures because of the presence of a network of microcrystallites formed by partial crystallization of the hard segments. The ratio of hard to soft segments determines the characteristics of the material. Thus, another advantage to thermoplastic polyester elastomers is that soft elastomers and hard elastoplastics can be produced by changing the ratio of the hard and soft segments.

In one particular embodiment, the polyester thermoplastic elastomer has the following formula: −[4GT]ₓ[BT]_{y}, wherein 4G is butylene glycol, such as 1,4-butane diol, B is poly(tetramethylene ether glycol) and T is terephthalate, and wherein x is from about 0.60 to about 0.99 and y is from about 0.01 to about 0.40.

In one aspect, the thermoplastic polyester elastomer can be a block copolymer of polybutylene terephthalate and polyether segments and/or dimerdiol segments and can have a structure as follows:

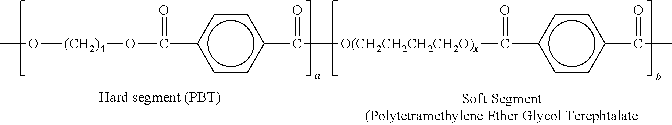

wherein a and b are integers and can vary from 2 to 50,000, such as from about 2 to about 10,000. The ratio between hard and soft segments in the block copolymer as described above can be varied in order to vary the properties of the elastomer.

In one aspect, the polymer composition can contain a copolyester elastomer comprising a block copolymer containing polybutylene terephthalate segments and polytetramethylene ether glycol terephthalate segments.

In one aspect, the density of the polyester elastomer as indicated above can be from about 1.05 g/cm³ to about 1.15 g/cm³, such as from about 1.08 g/cm³ to about 1.1 g/cm³.

In one aspect, the copolyester elastomer can have a Shore D hardness of less than about 100, such as less than about 90, such as less than about 80, such as less than about 70, such as less than about 60, such as less than about 50. The Shore D hardness of the elastomer can generally be greater than about 10, such as greater than about 20, such as greater than about 30.

In accordance with the present disclosure, the pre-compounded polymer composition contains, in one embodiment, thermoplastic elastomer pellets combined with a thermoplastic elastomer powder. The thermoplastic elastomer present in the pellets and the powder can be a copolyester elastomer as described above. In one embodiment, both the pellets and the powder contain the same copolyester elastomer, such as a block copolymer containing polybutylene terephthalate segments and dimerdiol segments. For example, in one embodiment, both the pellets and the powder contain a block copolymer of polybutylene terephthalate segments combined with polytetramethylene ether glycol terephthalate segments. Alternatively, the pellets and the powder can each contain different copolyester elastomers or the pellets and the powder can contain a blend of copolyester elastomers. For example, in one embodiment, the pre-compounded polymer composition may contain a copolyester elastomer containing polyether segments with a copolyester elastomer containing dimerdiol segments.

The pre-compounded polymer composition generally contains the thermoplastic elastomer pellets in an amount greater than about 80% by weight, such as in an amount greater than about 85% by weight, such as in an amount greater than about 88% by weight. The thermoplastic elastomer pellets are generally present in the composition in an amount less than about 95% by weight, such as in an amount less than about 93% by weight, such as in an amount less than about 90% by weight. The pellets can generally have a length to width ratio of from about 4:1 to about 1:1, such as from about 2:1 to about 1:1, such as from about 1.5:1 to about 1:1. In one aspect, the pellets can have a length of greater than about 1 mm, such as greater than about 1.5 mm, such as greater than about 1.75 mm, and generally less than about 4 mm, such as less than about 3 mm, such as less than about 2.5 mm. The width of the pellets can generally be greater than about 0.25 mm, such as greater than about 0.5 mm, such as greater than about 0.75 mm, and generally less than about 2 mm, such as less than about 1.75 mm, such as less than about 1.5 mm, such as less than about 1.25 mm.

In accordance with the present disclosure, the thermoplastic elastomer pellets are combined with a thermoplastic elastomer powder. It is believed that during melt processing, the powder allows for better mixing and blending of other components with the thermoplastic elastomer. The thermoplastic elastomer powder can be present in the pre-compounded polymer composition generally in an amount greater than about 3% by weight, such as in an amount greater than about 5% by weight, such as in an amount greater than about 8% by weight. The thermoplastic elastomer powder is generally present in an amount less than about 30% by weight, such as in an amount less than about 25% by weight, such as in an amount less than about 20% by weight, such as in an amount less than about 15% by weight, such as in an amount less than about 10% by weight. The thermoplastic elastomer powder can have an average (D₅₀) particle size of from about 250 microns to about 1200 microns. The average particle size of the powder, for instance, can be greater than about 300 microns, such as greater than about 350 microns, such as greater than about 400 microns, such as greater than about 450 microns, such as greater than about 500 microns, such as greater than about 550 microns, such as greater than about 600 microns. The average particle size of the powder is generally less than about 1,000 microns, such as less than about 950 microns, such as less than about 900 microns, such as less than about 850 microns, such as less than about 800 microns, such as less than about 750 microns, such as less than about 700 microns, such as less than about 650 microns. In accordance with the present disclosure, particle sizes can be measured according to a sieve test using standard size sieve screens. For example, particle size can be determined by placing a 200 gram sample of the particles in a RO-TAP AS200 automatic shaker available from Retsch containing different size sieve screens. The amplitude setting is 1.25 mm/g and the shake time is 15 minutes.

In one aspect, the thermoplastic elastomer powder does not contain any particles having a size greater than about 2,000 microns, such as greater than about 1,700 microns, such as greater than about 1,500 microns, such as greater than about 1,200 microns. From about 15% by weight to about 50% by weight, such as from about 19% by weight to about 42% by weight, such as from about 25% by weight to about 35% by weight of the particles have a mesh size of 1,000 microns. From about 10% by weight to about 20% by weight, such as from about 13% by weight to about 18% by weight, such as from about 13% by weight to about 17% by weight of the particles can have a mesh size of about 710 microns. From about 8% by weight to about 20% by weight, such as from about 12% by weight to about 16% by weight, such as from about 13% by weight to about 15% by weight of the particles can have a mesh size of about 500 microns. From about 10% by weight to about 40% by weight, such as from about 16% by weight to about 32% by weight, such as from about 22% by weight to about 27% by weight of the particles can have mesh size of about 250 microns. The powder can contain particles having a mesh size of less than about 250 microns in an amount less than about 20% by weight, such as in an amount less than about 16% by weight, such as in an amount less than about 14% by weight, such as in an amount less than about 10% by weight, such as in an amount less than about 5% by weight, such as in an amount less than about 3% by weight.

As described above, the thermoplastic elastomer powder has been found to significantly contribute to producing a homogeneous compounded products when the pre-compounded polymer composition is melt blended. Consequently, the pre-compounded polymer composition can contain various additives, ingredients or components that are to be blended with the thermoplastic elastomer.

For example, in one embodiment, the pre-compounded polymer composition contains one or more coloring agents that, through the formulation and process of the present disclosure, can later produce molded articles having dramatically improved aesthetic properties. The one or more coloring agents incorporated into the polymer composition generally are color pigments. One or more color pigments can be present in the polymer composition in an amount greater than about 0.01% by weight, such as in an amount greater than about 0.1% by weight, such as in an amount greater than about 0.2% by weight. One or more color pigments are generally present in an amount less than about 1.5% by weight, such as in an amount less than about 1% by weight, such as in an amount less than about 0.9% by weight, such as in an amount less than about 0.8% by weight.

Various different color pigments can be incorporated into the polymer composition. Coloring agents or pigments that are particularly well suited for combining with elastomers of the present disclosure include the following: PY 138, PY 128, PY 53, PY 184, PY 109, PY 151, PY 168, PY 93, PY 94, PY 214, PY 120, PY 215, PY 17, PY 34, PY 81, PY 180, PY 191, PY 191:1, PY 183, PY 229, PY 95, PY 62, PY 61, PY 13, PY 150, PY 147, PY 35, PY 37, PY 83, PY 110, PY 139, PY 181, PBr 24, PY 119, PY 163, PY 42, PO 64, PO 79, PO 71, PO 73, PO 68, PO 43, PO 61, PO 34, PO 82, PO 85, PO 72, PO 13, PO 38, PO 20, PY 164, PBr 23, PBr 25, PBr 41, PBr 48, PBr 29, PBk 12, PBr 33, PR 242, PR 166, PR 101, PR 290, PR 53:1, PR 53:2, PR 53:3, PR 53:4, PR 283, PR 48:1, PR 48:3, PR 48:4, PR 48:5, PR 149, PR 38, PR 48:2, PR 254, PR 272, PR 220, PV 19, PR 285, PR 170, PR 178, PR 208, PR 262, PR 108, PR 264, PR 144, PR 214, PR 177, PR 221, PR 187, PR 179, PR 185, PR 176, PR 202, PR 122, PV 19, PV 23, PV 37, PV 15, PV 16, PV 29, PV 32, PB 29, PB 60, PB 28, PB 36, PB 15, PB 15:1, PB 15:2, PB 15:3, PB 15:4, PB 15:5, PB 15:6, PB 16, PG 17, PG 50, PG 7, PG 36, PG 26, PW 4, PW 5, PW 6, PW 7, PBk 7, PBk 9, PBk 28, PBr 29, PBk 30, PBk 11, PBk 26, PBk 27 or mixtures thereof.

Color pigments that have been found particularly well suited for use in the present disclosure include the following: PO 64, PR 254, PBk 12, PG 17, PB 29, PBk 7, PW 6, PR 101, PY 119, PB 15:1, PR 122, PV 19, PB 15:4, PY 138, PY 110, PR 202 or mixtures thereof.

Particular pigments that can be incorporated into the present disclosure include the following.

Cromophtal Orange K 2960 belongs to the Color Index of Pigment Orange 64 and has a composition containing C₁₂H₁₀N₆O₄. The molecular weight of Cromophtal Orange is 302.3 g/mol, and it has a density of 1.9 g/cm³. The average particle size is 94 nm;

DPP Red 1354 belongs to the Color Index of Pigment Red 254 and has a composition containing C₁₈H₁₀Cl₂N₄O₆. The molecular weight of DPP Red 1354 is 357.2 g/mol, and has a density of 1.6 g/cm³. The average particle size ranges from 200-280 nm;

Brown 19 belongs to the Color Index of Pigment Brown 19 and has a composition containing C₂₀H₂₀Cl₂N₄O₆. The molecular weight of Brown 19 is 483.3 g/mol;

Green V-11674 belongs to the Color Index Pigment Green 17 and has a composition containing Cr₂O₃. The molecular weight of Green V-11674 is 151.9, and has a density of 5.22 g/cm³. The average particle size ranges from 1500-1800 nm;

Ultramarine Blue belongs to the Color Index Pigment Blue 29:77007 and has a composition containing Na₂OSAl₂O₃SiO₂. The molecular weight of Ultramarine Blue is 256.1 g/mol, and has a density of 2.35 g/cm³. The average particle size is 1660 nm;

Black Pearls 880 belongs to the Color Index Pigment Black 6 (commonly referred to as Carbon Black) and has a composition containing Carbon. The molecular weight of Black Pearls 880 is 12.01 g/mol, and it has a density of 1.7 g/cm³. The average particle size ranges from 8-300 nm;

Kronos 2211 belongs to the Color Index Pigment White 6 and has a composition containing TiO₂. The molecular weight of Kronos 2211 is 79.9 g/mol, and has a density of 4.1 g/cm³. The average particle size ranges from 15-30 nm;

Bayferrox 180M belongs to the Color Index Pigment Red 180 (commonly referred to as Iron Oxide Red) and has a composition containing Fe₂O₃. The molecular weight of Bayferrox 180M is 159.7 g/mol, and has a density of 5.2 g/cm³. The average particle size ranges from 20-180 nm, with a mean particle size of 85 nm;

Buff V-9115 belongs to the Color Index Pigment Yellow 119 and has a composition containing ZnFe₂O₄. The molecular weight of Buff V-9915 is 159.7 g/mol, and it has a density of 5.1 g/cm³. The average particle size ranges from 10-62 nm;

Heliogen Blue K 6911 belongs to the Color Index Pigment Blue 15:1 and has a composition containing C₃₂H₁₆CuN₈. The molecular weight of Heliogen Blue K 6911 is 576.1 g/mol, and has a density of 1.6 g/cm³. The average particle size is 723 nm;

Hostaform Pink E 13-7000 belongs to the Color Index Pigment Red 122 and has a composition containing C₂₂H₁₆N₂O₂. The molecular weight of Hostafrom Pink E 13-700 340.4 g/mol, and has a density of 1.3 g/cm³. The average particle size is 113 nm;

Hostaperm Red E5B-02 belongs to the Color Index Pigment Violet 19 and has a composition containing C₂₀H₁₂N₂O₂. The molecular weight of Hostaperm Red E5B-02 is 312.3 g/mol, and has a density of 1.8 g/cm³. The average particle size ranges from 50-100 nm;

Sunfast Blue 249-3450 belongs to the Color Index Pigment Blue 15:4 and has a composition containing C₃₂H₁₆CuN₈. The molecular weight of Sunfast Blue 249-3450 is 576.1 g/mol, and has a density of 1.5 g/cm³. The average particle size ranges from 40,000-60,000 nm;

Paliotol Yellow K 0961 belongs to the Color Index Pigment Yellow 138 and has a composition containing C₂₆H₆C₁₈N₂O₄ (commonly known as Chinophthalone Yellow). The molecular weight of Paliotol Yellow K 0961 is 639.9 g/mol, and it has a density of 1.8 g/cm³. The average particle size is 459 nm;

Irgazin Yellow K 2070 belongs to the Color Index Pigment Yellow 110 and has a composition containing C₂₂H₆Cl₈N₄O₂. The molecular weight of Irgazin Yellow K 2070 is 641.9 g/mol, and it has a density of 1.3 g/cm³. The average particle size ranges from 200-300 nm; and

Cinquasia Magenta K 4535 belongs to the Color Index Pigment Reg 202 and has a composition containing C₂₀H₁₀Cl₂N₂O₂. The molecular weight of Cinquasia Magenta K 4535 is 381.2 g/mol, and it has a density of 1.61 g/cm³. The average particle size ranges from 250-300 nm.

Problems have been experienced in the past in creating a homogenized color distribution in articles made through rotational molding. The above pre-compounded polymer composition, however, has been found to dramatically improve the uniformity of color in articles made from the composition.

In addition to one or more coloring agents, however, various other components and ingredients can be incorporated into the pre-compounded polymer composition for improving homogeneity. It is believed that the combination of pellets and powder serve to obtain dramatically improved blending and mixing during melt processing.

### Compounded Polymer Composition

Once the pre-compounded polymer composition is formulated in accordance with the present disclosure, the mixture of components are melt blended together and formed into a compounded product for use in rotational molding processes.

For example, in one embodiment, the thermoplastic elastomer pellets are first dried in order to minimize moisture content. For instance, the pellets can be dried such that the resulting moisture content of the pellets is less than about 2% by weight, such as less than about 1.5% by weight, such as less than about 1% by weight, such as less than about 0.5% by weight, such as less than about 0.25% by weight, such as less than about 0.1% by weight.

Once the pellets are dried, the thermoplastic elastomer pellets can be combined with the thermoplastic elastomer powder and one or more coloring agents in any suitable mixing device, such as a drum tumbler mixer. The mixture or blend is then fed into an extruder which can be a single screw extruder or a twin screw extruder. Processing temperatures can vary depending upon the polymer formulation that is compounded. When using a single screw extruder, for instance, the temperature within the extruder can be from about 375° F. to about 510° F. When using a twin screw extruder, on the other hand, temperatures can vary from about 200° C. or 215° C. to about 260° C., such as to about 245° C.

In addition to the thermoplastic elastomer pellets, the thermoplastic elastomer powder, and optionally one or more coloring agents, the polymer composition that is melt blended and compounded together can contain various other ingredients and components. As described above, the use of a pellet and powder blend can produce a homogenous compounded product.

In one embodiment, for instance, a polyalkylene glycol can be incorporated into the polymer composition for providing various advantages and benefits. The polyalkylene glycol, for instance, can improve flow properties of the particles and/or can improve impact strength resistance.

Polyalkylene glycols particularly well suited for use in the polymer composition include polyethylene glycols, polypropylene glycols, and mixtures thereof.

The molecular weight of the polyalkylene glycol can vary depending upon various factors including the characteristics of the polyoxymethylene polymer and the process conditions for producing shaped articles. In one aspect, the polyalkylene glycol, such as the polyethylene glycol, can have a relatively low molecular weight. For example, the molecular weight can be less than about 10,000 g/mol, such as less than about 8,000 g/mol, such as less than about 6,000 g/mol, such as less than about 4,000 g/mol, and generally greater than about 1000 g/mol, such as greater than about 2000 g/mol. In one embodiment, a polyethylene glycol plasticizer is incorporated into the polymer composition that has a molecular weight of from about 2000 g/mol to about 5000 g/mol.

In another aspect, a polyalkylene glycol, such as the polyethylene glycol, can be selected that has a higher molecular weight. For example, the molecular weight of the polyalkylene glycol can be about 10,000 g/mol or greater, such as greater than about 20,000 g/mol, such as greater than about 30,000 g/mol, such as greater than about 35,000 g/mol, and generally less than about 100,000 g/mol, such as less than about 50,000 g/mol, such as less than about 45,000 g/mol, such as less than about 40,000 g/mol.

When present in the polymer composition, the polyalkylene glycol can be added in amounts greater than about 0.1% by weight, such as in an amount greater than about 0.3% by weight. The polyalkylene glycol can generally be present in the polymer composition in an amount less than about 5% by weight, such as in an amount less than about 3% by weight, such as in an amount less than about 1% by weight.

The polymer composition of the present disclosure can also optionally contain a stabilizer and/or various other additives. Such additives can include, for example, antioxidants, acid scavengers, UV stabilizers or heat stabilizers. In addition, the polymer composition may contain processing auxiliaries, for example adhesion promoters, or antistatic agents.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2H-benzotriazole-2-yl)-4,6-bis(1-methyl-1-phenylethyl) phenol; 2-(2′-hydroxyphenyl)benzotriazoles, e.g., 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide, cyanoacrylates, e.g., ethykalpha.-cyano-.beta.,.beta.-diphenylacrylate and methyl-2-cyano-3-methyl-3-(p-methoxyphenyl)acrylate or mixtures thereof. A specific example of an ultraviolet light absorber that may be present is UV 234, which is a high molecular weight ultraviolet light absorber of the hydroxyl phenyl benzotriazole class. The UV light absorber, when present, can be present in the polymer composition in an amount ranging from about 0.1% by weight to about 2% by weight, such as in an amount ranging from about 0.25% by weight to about 1% by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy methylphenyl)propionate] (IRGANOX® 245, BASF), 3,3′-bis[3-(3,5-di-tert-butyl hydroxyphenyl)propionohydrazide] (IRGANOX® MD 1024, BASF), hexamethylene glycol bis[3-(3,5-di-cert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 1% by weight based on the total weight of the polymer composition.

Light stabilizers that may be present in addition to the ultraviolet light stabilizer in the composition include sterically hindered amines. Hindered amine light stabilizers that may be used include oligomeric compounds that are N-methylated. In one aspect, the light stabilizer can comprise bis(2,2,6,6-tetramethyl-4-piperidyl)sebaceate. For instance, one example of a hindered amine light stabilizer comprises ADK STAB LA-63 light stabilizer available from Adeka Palmarole. The light stabilizers, when present, can be present in the polymer composition in an amount ranging from about 0.1% by weight to about 2% by weight, such as in an amount ranging from about 0.25% by weight to about 1% by weight based on the total weight of the polymer composition.

In addition to the above components, the polymer composition may also contain an acid scavenger. The acid scavenger may comprise, for instance, an alkaline earth metal salt. For instance, the acid scavenger may comprise a calcium salt, such as a calcium citrate. In one aspect, the calcium citrate is a tricalcium citrate. Another acid scavenger well suited for use in the polymer composition is calcium propionate anhydrous. The acid scavenger may be present in an amount ranging from about 0.01% by weight to about 1% by weight based on the total weight of the polymer composition.

In one embodiment, a lubricant may be present. The lubricant can comprise a polymer wax composition. For example, a fatty acid amide may be used. One example of a fatty acid amide is ethylene bis(stearamide). Alternatively, the lubricant can comprise a polyethylene wax. Lubricants may generally be present in the polymer composition in an amount from about 0.01% by weight to about 1% by weight.

As described above, the compounded polymer composition can be melt blended using an extruder. In one embodiment, extruded strands can be produced which are then pelletized. The pelletized compound can then be ground to a suitable particle size and to a suitable particle size distribution to produce a powder that is well suited for use in rotational molding.

For example, any suitable hammermill or granulator may be used to produce the powder composition. In one embodiment, cryogenic grinding is used to produce particles having a relatively small size and a uniform particle size distribution. Cryogenic grinding, for instance, can produce a powder not only having a uniform size but also having particles that are approximately spherical in shape.

In one aspect, the average particle size (D₅₀) of the polymer composition is greater than about 300 microns, such as greater than about 350 microns, such as greater than about 400 microns, such as greater than about 450 microns, such as greater than about 500 microns, and generally less than about 1,000 microns, such as less than about 900 microns, such as less than about 850 microns. It was discovered that the above average particle size is well suited for use in rotational molding processes.

In one aspect, the ground powder can have a D₉₀ particle size such that greater than about 10% by weight of the particles have a particle size of greater than about 600 microns, such as greater than about 850 microns, and generally less than about 1,200 microns, such as less than about 1,000 microns.

The particle size distribution of the polymer composition can be selected so as to have an optimum bulk density and flowability for use in rotomolding applications. Flowability and bulk density are measured according to “Test Method for Flowability (Dry Flow Rate) and Apparent Density (Bulk Density) of Polyethylene Powders,” Version 2.1 dated November 2011 and published by the Association of Rotational Molders. In accordance with the present disclosure, the polymer composition can have a bulk density of generally greater than about 300 g/L, such as greater than about 350 g/L, such as greater than about 400 g/L, such as greater than about 450 g/L, and generally less than about 650 g/L, such as less than about 600 g/L, such as less than about 550 g/L, such as less than about 500 g/L. The polymer composition can have a flowability of less than about 50 sec/100 g, such as less than about 45 sec/100 g, such as less than about 40 sec/100 g, such as less than about 35 sec/100 g, such as less than about 30 sec/100 g, and generally greater than about 5 sec/100 g, such as greater than about 15 sec/100 g, such as greater than about 25 sec/100 g.

It was found that polymer compositions formulated according to the present disclosure and having a particle size distribution as described above can produce rotationally molded articles in very rapid cycle times with minimal material consumption.

### Rotationally Molded Articles

Once the polymer composition is formulated and formed into a powder having a controlled particle size distribution, the polymer particles are loaded into a mold for producing molded articles. The polymer particles are particularly well suited for use in rotational molding processes. During rotational molding, the polymer particles are loaded into a mold and the mold is rotated at least about a first axis and a second axis while being heated. The polymer composition is heated to a molten temperature, causing the polymer composition to flow and coat the interior walls of the mold for producing hollow vessels.

All different types of hollow articles can be produced in accordance with the present disclosure. The articles can have any desired shape and include a seamless wall made from the polymer composition of the present disclosure. The article can define an interior volume. Rotational molding can be used to produce small items and large items.

When producing articles made according to the present disclosure, the polymer composition produces an outer shell that is strong and flexible. For example, when tested according to ASTM Test 4833, the article can have a puncture resistance of greater than about 150 lbs., such as greater than about 160 lbs., such as greater than about 170 lbs., such as greater than about 180 lbs., such as greater than about 190 lbs., such as greater than about 200 lbs., and generally less than about 400 lbs. By being seamless, the exterior surface of the article is not only flexible but can be waterproof.

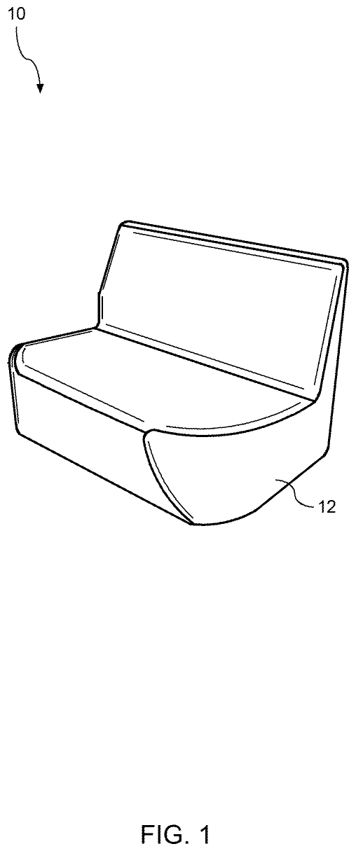

In one application, the polymer composition of the present disclosure is used to form an exterior covering, such as for furniture. Referring to FIG. 1, for instance, a seat or bench 10 is shown that includes an outer covering 12 made in accordance with the present disclosure. The outer covering 12 can have any suitable shape and be placed over any type of material that provides a cushion and support, such as high density foam. As shown in FIG. 1, the outer covering 12 comprises a single integral piece of material and contains no seams.

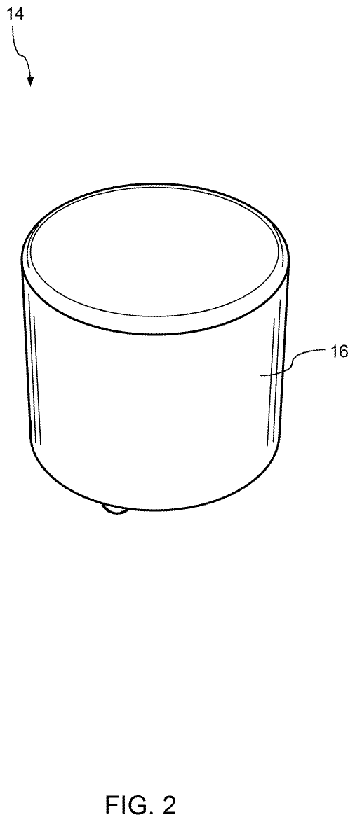

Referring to FIG. 2, another embodiment of furniture made in accordance with the present disclosure is shown. In this embodiment, the furniture comprises a stool 14 that includes an outer covering 16 made in accordance with the present disclosure. As shown in FIGS. 1 and 2, the outer coverings 12 and 16 can not only be made with various different shapes but also have surface conforming properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition for producing a compounded feed material for use in rotational molding processes, the polymer composition comprising:
copolyester elastomer pellets, the copolyester elastomer pellets being present in the composition in an amount from about 80% by weight to about 95% by weight;
a copolyester elastomer powder, the copolyester elastomer powder being present in the polymer composition in an amount from about 5% by weight to about 20% by weight; and
one or more coloring agents comprising color pigments, the one or more coloring agents being present in the polymer composition in an amount from about 0.01% by weight to about 1% by weight.

2. A polymer composition as defined in claim 1, wherein the copolyester elastomer pellets are present in the polymer composition in an amount from about 88% by weight to about 92% by weight, the copolyester elastomer powder being present in the polymer composition in an amount from about 8% by weight to about 12% by weight, and wherein the one or more coloring agents are present in the polymer composition in an amount from about 0.01% by weight to about 0.8% by weight.

3. A polymer composition as defined in claim 1, wherein the copolyester elastomer pellets have an average length of from about 0.5 mm to about 3.5 mm.

4. A polymer composition as defined in claim 1, wherein the copolyester elastomer powder has an average particle size of from about 250 microns to about 1000 microns.

5. A polymer composition as defined in claim 1, wherein the one or more coloring agents are selected from PY 138, PY 128, PY 53, PY 184, PY 109, PY 151, PY 168, PY 93, PY 94, PY 214, PY 120, PY 215, PY 17, PY 34, PY 81, PY 180, PY 191, PY 191:1, PY 183, PY 229, PY 95, PY 62, PY 61, PY 13, PY 150, PY 147, PY 35, PY 37, PY 83, PY 110, PY 139, PY 181, PBr 24, PY 119, PY 163, PY 42, PO 64, PO 79, PO 71, PO 73, PO 68, PO 43, PO 61, PO 34, PO 82, PO 85, PO 72, PO 13, PO 38, PO 20, PY 164, PBr 23, PBr 25, PBr 41, PBr 48, PBr 29, PBk 12, PBr 33, PR 242, PR 166, PR 101, PR 290, PR 53:1, PR 53:2, PR 53:3, PR 53:4, PR 283, PR 48:1, PR 48:3, PR 48:4, PR 48:5, PR 149, PR 38, PR 48:2, PR 254, PR 272, PR 220, PV 19, PR 285, PR 170, PR 178, PR 208, PR 262, PR 108, PR 264, PR 144, PR 214, PR 177, PR 221, PR 187, PR 179, PR 185, PR 176, PR 202, PR 122, PV 19, PV 23, PV 37, PV 15, PV 16, PV 29, PV 32, PB 29, PB 60, PB 28, PB 36, PB 15, PB 15:1, PB 15:2, PB 15:3, PB 15:4, PB 15:5, PB 15:6, PB 16, PG 17, PG 50, PG 7, PG 36, PG 26, PW 4, PW 5, PW 6, PW 7, PBk 7, PBk 9, PBk 28, PBr 29, PBk 30, PBk 11, PBk 26, PBk 27, or mixtures thereof.

6. A polymer composition as defined in claim 1, wherein the one or more coloring agents are selected from PO 64, PR 254, PBk 12, PG 17, PB 29, PBk 7, PW 6, PR 101, PY 119, PB 15:1, PR 122, PV 19, PB 15:4, PY 138, PY 110, PR 202, or mixtures thereof.

7. A polymer composition as defined in claim 1, wherein the copolyester elastomer pellets, the copolyester elastomer powder, or both comprise a block copolymer of polybutylene terephthalate and a polyether or dimerdiol segments.

8. A polymer composition as defined in claim 1, wherein the copolyester elastomer pellets, the copolyester elastomer powder, or both comprise a thermoplastic ester ether elastomer.

9. A polymer composition as defined in claim 1, wherein the copolyester elastomer pellets, the copolyester elastomer powder, or both comprise a block copolymer of polybutylene terephthalate and polytetramethylene ether glycol terephthalate segments.

10. A polymer composition as defined in claim 1, wherein the copolyester elastomer pellets, the copolyester elastomer powder, or both contain a copolyester elastomer having a Shore D hardness of less than about 80 and greater than about 10.

11. A polymer composition as defined in claim 1, wherein the copolyester elastomer pellets contain a first copolyester elastomer and the copolyester elastomer powder contains a second copolyester elastomer and wherein the first copolyester elastomer is the same as the second copolyester elastomer.

12. A polymer composition as defined in claim 1, wherein the copolyester elastomer pellets contain a first copolyester elastomer and the copolyester elastomer powder contains a second copolyester elastomer and wherein the first copolyester elastomer is different than the second copolyester elastomer.

13. A compounded feed material formed from the polymer composition as defined in claim 1.

14. A compounded feed material as defined in claim 13, wherein the compounded feed material is in the form of pellets.

15. A polymer composition for rotational molding applications comprising:
polymer particles comprising a copolyester elastomer blended with at least one coloring agent, the copolyester elastomer being present in the polymer composition in an amount greater than about 80% by weight, the polymer particles having an average particle size of from about 400 microns to about 1,100 microns, the polymer particles having a bulk density of from about 300 g/L to about 650 g/L.

16. A polymer composition as defined in claim 15, wherein the polymer particles have a bulk density of from about 400 g/L to about 550 g/L.

17. A polymer composition as defined in claim 15, wherein the polymer particles have a flowability of less than about 40 sec/100 g.

18. A polymer composition as defined in claim 15, wherein the polymer particles have an average particle size of from about 750 microns to about 950 microns.

19. A polymer composition as defined in claim 15, wherein the copolyester elastomer comprises a block copolymer of polybutylene terephthalate and a polyether or dimerdiol segments.

20. A polymer composition as defined in claim 15, wherein the copolyester elastomer comprises a block copolymer of polybutylene terephthalate and polytetramethylene ether glycol terephthalate segments.
